(19) United States
(12) Patent Application Publication
(10) Pub. No.: US 2021/0406705 A1
(43) Pub. Date: Dec. 30, 2021

(54) SYSTEM AND METHOD FOR COLLECTING TRAINING DATA

(71) Applicant: KOMATSU INDUSTRIES CORPORATION, Kanazawa-shi, Ishikawa (JP)

(72) Inventors: Kouji FUNABASHI, Ishikawa (JP); Yusuke MASATO, Ishikawa (JP); Taketoshi FUKUMURA, Ishikawa (JP); Eiji DOBA, Ishikawa (JP)

(21) Appl. No.: 17/293,306

(22) PCT Filed: Dec. 17, 2019
(86) PCT No.: PCT/JP2019/049430

§ 371 Date: May 12, 2021

(30) Foreign Application Priority Data
Feb. 28, 2019 (JP) 2019-035971

(51) Int. Cl. G06N 5/02; G05B 23/02; B30B 15/28

(52) U.S. Cl. CPC G06N 5/022; B30B 15/28; G05B 23/0243

(57) ABSTRACT

A system collects training data in order to train a determination model of artificial intelligence that determines an abnormality of an industrial machine. The system includes a storage device and a processor. The storage device stores state data indicative of a state of the industrial machine acquired in time series. The processor determines an occurrence of a trigger related to an occurrence of the abnormality in the industrial machine, and extracts data corresponding to the trigger from the state data when the trigger occurs. The processor stores the data corresponding to the trigger as the training data.

### CROSS-REFERENCE TO RELATED APPLICATIONS

This application is a U.S. National stage application of International Application No. PCT/JP2019/049430, filed on Dec. 17, 2019. This U.S. National stage application claims priority under 35 U.S.C. § 119(a) to Japanese Patent Application No. 2019-035971, filed in Japan on Feb. 28, 2019, the entire contents of which are hereby incorporated herein by reference.

### BACKGROUND

### Field of the Invention

The present disclosure relates to a system and a method for collecting training data for training an artificial intelligence determination model for determining an abnormality of an industrial machine.

### Background Information

Industrial machine may be required to detect an occurrence of abnormalities. Therefore, in the conventional technique, an abnormality is determined by detecting a predetermined output value of an industrial machine by a sensor and comparing the detected output value with a threshold value (see, for example, Japanese Patent Laid-Open No. H02-195498).

### SUMMARY

In order to prevent a stoppage due to a failure or reduce maintenance costs in an industrial machine, it is important to detect that the machine is approaching an abnormal state and perform maintenance before the machine breaks down. However, with the above-mentioned conventional technique, it is not easy to accurately detect that the industrial machine is approaching an abnormal state.

In recent years, a technique for detecting an abnormality in a machine has been provided by using a determination model of artificial intelligence (hereinafter referred to as “AI”). In the AI determination model, data indicating an abnormality of the machine has been learned as training data. Therefore, in order to improve the accuracy of abnormality detection, it is important to collect a large amount of data indicating machine abnormalities. However, it is not easy to collect a lot of data indicating machine abnormalities. In addition, if normal machine data is erroneously included in the training model, the accuracy of abnormality detection by AI will decrease.

An object of the present disclosure is to easily collect accurate training data for training an artificial intelligence determination model for determining an abnormality of an industrial machine.

A first aspect is a system for collecting training data for training a determination model of artificial intelligence for determining an abnormality of an industrial machine. The system includes a storage device and a processor. The storage device stores state data acquired in time series. The state data shows a state of the industrial machine. The processor determines an occurrence of a trigger related to an occurrence of an abnormality in the industrial machine. When the trigger occurs, the processor extracts data corresponding to the trigger from the state data. The processor stores the data corresponding to the trigger as training data.

A second aspect is a method executed by a processor for collecting training data for training a determination model of artificial intelligence that determines an abnormality in an industrial machine. The method includes the following processing. A first process is to acquire state data in time series. The state data shows a state of the industrial machine. A second process is to store the state data. A third process is to determine an occurrence of a trigger related to an occurrence of an abnormality in the industrial machine. A fourth process is to extract data corresponding to the trigger from the state data when the trigger occurs. A fifth process is to store the data corresponding to the trigger as training data.

According to the present disclosure, it is possible to easily collect accurate training data for training a determination model of artificial intelligence for determining an abnormality of an industrial machine.

### BRIEF DESCRIPTION OF THE DRAWINGS

FIG. 1 is a schematic diagram showing a predictive maintenance system according to an embodiment.

FIG. 2 is a front view of an industrial machine.

FIG. 3 is a diagram showing a slide drive system.

FIG. 4 is a diagram showing a die cushion drive system.

FIG. 5 is a flowchart showing a process executed by a local computer.

FIG. 6 is a diagram showing an example of analysis data.

FIG. 7 is a flowchart showing a process executed by a server.

FIG. 8 is a flowchart showing a process executed by the local computer.

FIG. 9 is a flowchart showing a process executed by the server.

FIG. 10A and FIG. 10B are diagrams showing a determination model.

FIG. 11A and FIG. 11B are diagrams showing an example of training data.

FIG. 12 is a diagram showing an example of a maintenance management screen.

FIG. 13 is a diagram showing an example of the maintenance management screen.

FIG. 14 is a diagram showing an example of a maintenance part management screen.

FIG. 15 is a diagram showing a structure of a learning system.

### DETAILED DESCRIPTION OF EMBODIMENT(S)

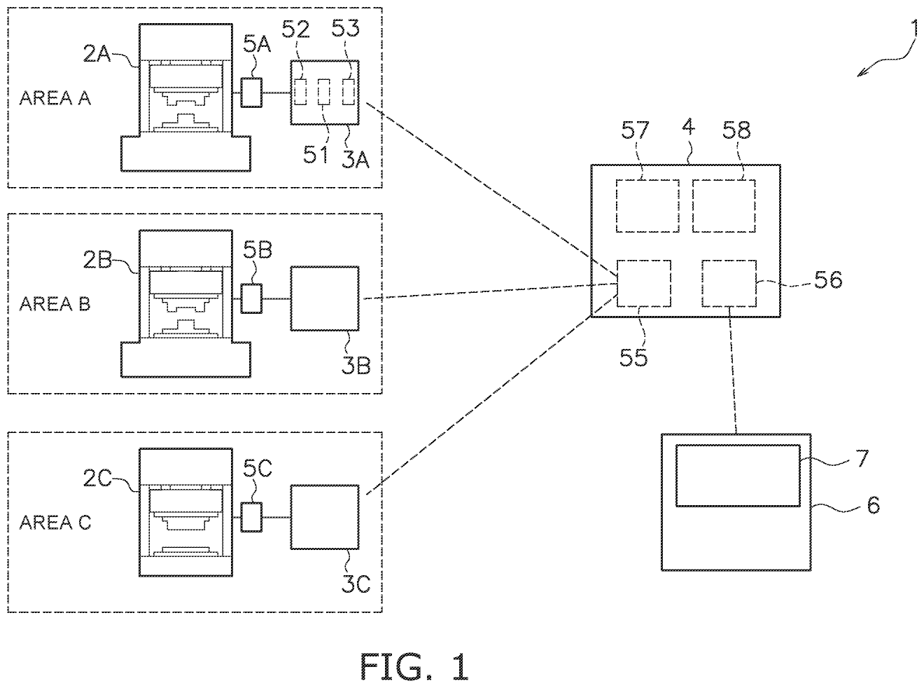

Hereinafter, embodiments will be described with reference to the drawings. FIG. 1 is a schematic diagram showing a predictive maintenance system 1 according to an embodiment. The predictive maintenance system 1 is a system for determining a part to be maintained before a failure occurs in an industrial machine. The predictive maintenance system 1 includes industrial machines 2A to 2C, local computers 3A to 3C, and a server 4.

As illustrated in FIG. 1, the industrial machines 2A to 2C may be arranged in different areas. Alternatively, the industrial machines 2A to 2C may be arranged in the same area. For example, the industrial machines 2A to 2C may be arranged in different factories. Alternatively, the industrial machines 2A to 2C may be arranged in the same factory. In the present embodiment, the industrial machine 2A to 2C is a press machine. In addition, in FIG. 1, three industrial machines are illustrated. However, the number of industrial machines may be less than three or more than three.

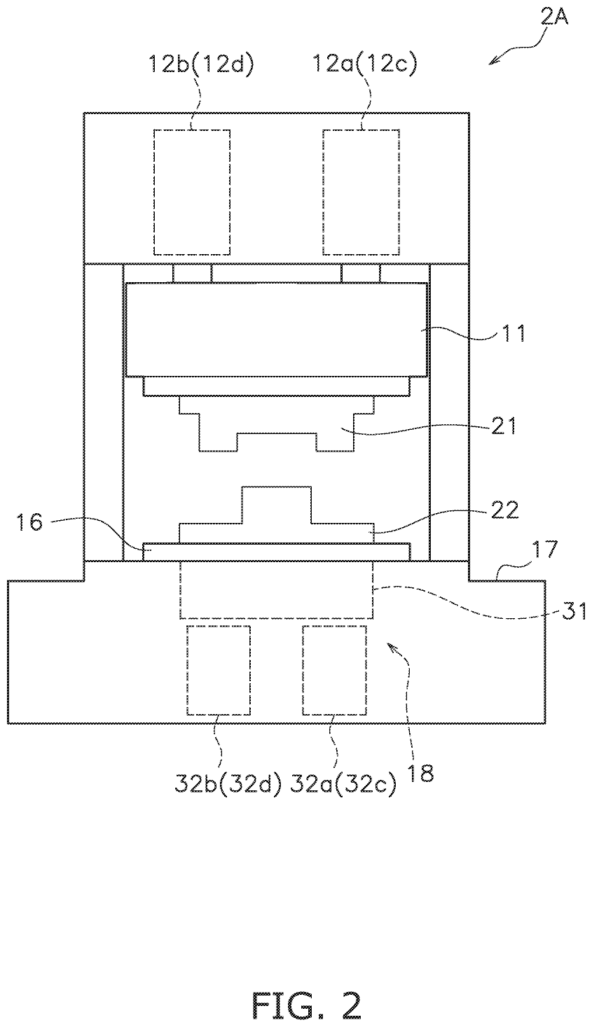

FIG. 2 is a front view of the industrial machine 2A. The industrial machine 2A includes a slider 11, a plurality of slide drive systems 12a to 12d, a bolster 16, a bed 17, a die cushion device 18, and a controller 5A (see FIG. 1). The slider 11 is configured to move up and down. An upper mold 21 is attached to the slider 11. The plurality of slide drive systems 12a to 12d operate the slider 11. The industrial machine 2A includes, for example, four slide drive systems 12a to 12d. In FIG. 2, two slide drive systems 12a and 12b are illustrated. The other slide drive systems 12c and 12d are arranged behind the slide drive systems 12a and 12b. However, the number of slide drive systems is not limited to four, and may be less than four or more than four.

The bolster 16 is arranged below the slider 11. A lower mold 22 is attached to the bolster 16. The bed 17 is arranged below the bolster 16. The die cushion device 18 applies an upward load to the lower mold 22 at the time of pressing. Specifically, the die cushion device 18 applies an upward load to the blank holder portion of the lower mold 22 during pressing. The controller 5A controls the operation of the slider 11 and the die cushion device 18.

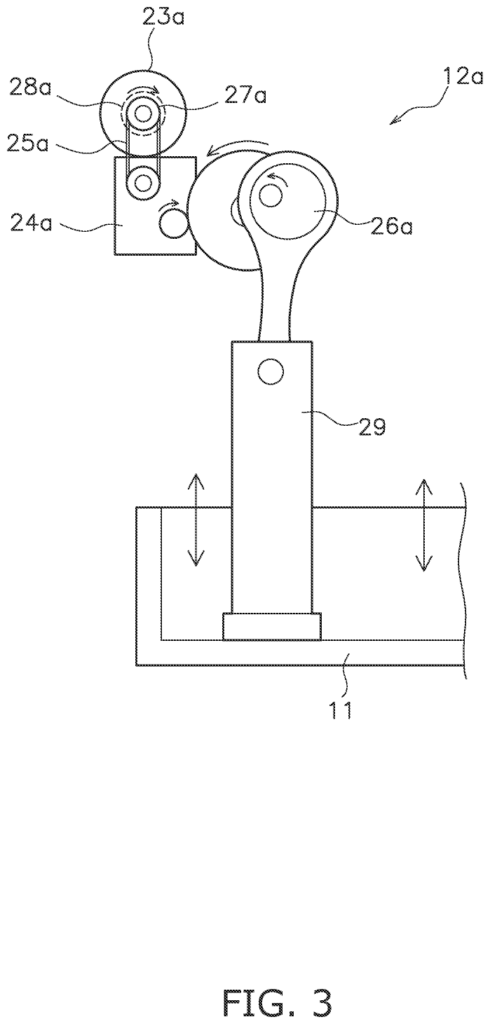

FIG. 3 is a diagram showing a slide drive system 12a. As illustrated in FIG. 3, the slide drive system 12a includes a plurality of parts such as a servomotor 23a, a speed reducer 24a, a timing belt 25a, and a connecting rod 26a. The servomotor 23a, the speed reducer 24a, the timing belt 25a, and the connecting rod 26a are connected to each other so as to operate in conjunction with each other.

The servomotor 23a is controlled by the controller 5A. The servomotor 23a includes an output shaft 27a and a motor bearing 28a. The motor bearing 28a supports the output shaft 27a. The speed reducer 24a includes a plurality of gears. The speed reducer 24a is connected to the output shaft 27a of the servomotor 23a via a timing belt 25a. The speed reducer 24a is connected to the connecting rod 26a. The connecting rod 26a is connected to a support shaft 29 of the slider 11. The support shaft 29 is slidable in the vertical direction with respect to the support shaft holder (not illustrated). The driving force of the servomotor 23a is transmitted to the slider 11 via the timing belt 25a, the speed reducer 24a, and the connecting rod 26a. As a result, the slider 11 moves up and down.

The other slide drive systems 12b to 12d also have the same configuration as the slide drive system 12a described above. In the following description, among the configurations of the other slide drive system 12b to 12d, those corresponding to the configurations of the slide drive system 12a have the same numbers as the configurations of the slide drive system 12a and the alphabets of the configurations of the slide drive systems 12b to 12d. For example, the slide drive system 12b includes a servomotor 23b. The slide drive system 12c includes a servomotor 23c.

As illustrated in FIG. 2, the die cushion device 18 includes a cushion pad 31 and a plurality of die cushion drive systems 32a to 32d. The cushion pad 31 is arranged below the bolster 16. The cushion pad 31 is configured to move up and down. The plurality of die cushion drive systems 32a to 32d operate the cushion pad 31 up and down. The industrial machine 2A includes, for example, four die cushion drive systems 32a to 32d. However, the number of die cushion drive systems is not limited to four, and may be less than four or more than four. In FIG. 2, two die cushion drive systems 32a and 32b are illustrated. The other die cushion drive systems 32c and 32d are arranged behind the die cushion drive systems 32a and 32b.

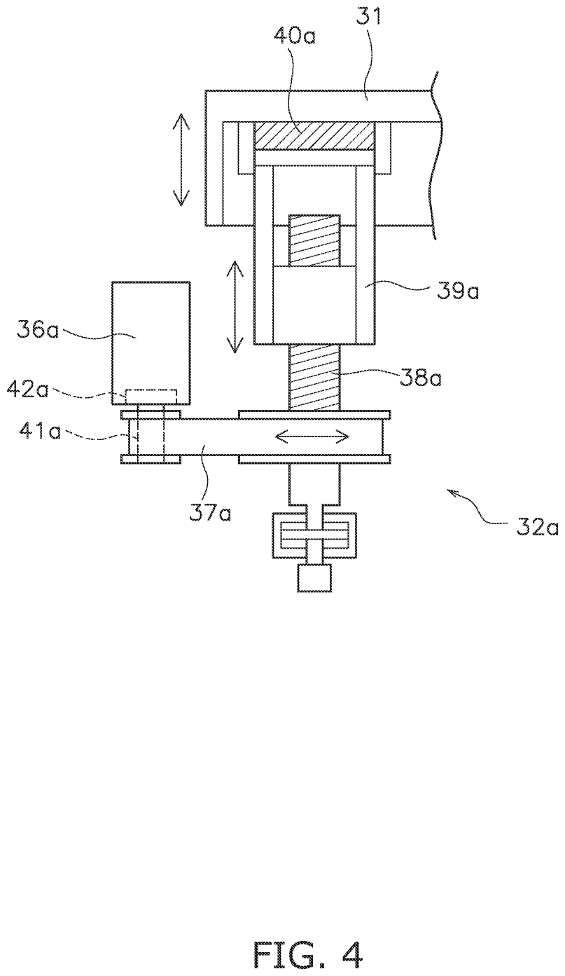

FIG. 4 is a diagram showing a die cushion drive system 32a. As illustrated in FIG. 4, the die cushion drive system 32a includes a plurality of parts such as a servomotor 36a, a timing belt 37a, a ball screw 38a, and a drive member 39a. The servomotor 36a, the timing belt 37a, and the ball screw 38a are connected to each other so as to operate in conjunction with each other. The servomotor 36a is controlled by the controller 5A. The servomotor 36a includes an output shaft 41a and a motor bearing 42a. The motor bearing 42a supports the output shaft 41a.

The output shaft 41a of the servomotor 36a is connected to the ball screw 38a via the timing belt 37a. The ball screw 38a moves up and down by rotating. The drive member 39a includes a nut portion that is screwed with the ball screw 38a. The drive member 39a moves upward by being pressed by the ball screw 38a. The drive member 39a includes a piston arranged in the oil chamber 40a. The drive member 39a supports the cushion pad 31 via the oil chamber 40a.

The other die cushion drive systems 32b to 32d also have the same configuration as the die cushion drive system 32a described above. In the following description, among the configurations of the other die cushion drive systems 32b to 32d, those corresponding to the configurations of the die cushion drive system 32a have the same numbers as the configurations of the die cushion drive system 32a and the alphabets of the configurations of the die cushion drive systems 32b to 32d. For example, the die cushion drive system 32b includes a servomotor 36b. The die cushion drive system 32c includes a servomotor 36c.

The configurations of the other industrial machines 2B and 2C are the same as those of the above-mentioned industrial machine 2A. As illustrated in FIG. 1, the industrial machines 2B and 2C are controlled by the controllers 5B and 5C, respectively. The industrial machines 2A to 2C may not be provided with a die cushion device. For example, the industrial machine 2C is a press machine without a die cushion device.

The local computers 3A to 3C communicate with the controllers 5A to 5C of the industrial machines 2A to 2C, respectively. As illustrated in FIG. 1, the local computer 3A includes a processor 51, a storage device 52, and a communication device 53. The processor 51 is, for example, a CPU (central processing unit). Alternatively, the processor 51 may be a processor different from the CPU. The processor 51 executes the process for predictive maintenance of the industrial machine 2A according to the program.

The storage device 52 includes a non-volatile memory such as ROM and a volatile memory such as RAM. The storage device 52 may include an auxiliary storage device such as a hard disk or an SSD (Solid State Drive). The storage device 52 is an example of a non-transitory recording medium that can be read by a computer. The storage device 52 stores computer commands and data for controlling the local computer 3A. The communication device 53 communicates with the server 4. The configurations of the other local computers 3B and 3C are the same as those of the local computer 3A.

The server 4 collects data for predictive maintenance from the industrial machines 2A to 2C via the local computers 3A to 3C. The server 4 executes the predictive maintenance service based on the collected data. In the predictive maintenance service, the parts to be maintained are specified. The server 4 communicates with the client computer 6. The server 4 provides a predictive maintenance service to the client computer 6.

The server 4 includes a first communication device 55, a second communication device 56, a processor 57, and a storage device 58. The first communication device 55 communicates with the local computers 3A to 3C. The second communication device 56 communicates with the client computer 6. The processor 57 is, for example, a CPU (central processing unit). Alternatively, the processor 57 may be a processor different from the CPU. The processor 57 executes the process for the predictive maintenance service according to the program.

The storage device 58 includes a non-volatile memory such as ROM and a volatile memory such as RAM. The storage device 58 may include an auxiliary storage device such as a hard disk or an SSD (Solid State Drive). The storage device 58 is an example of a non-transitory recording medium that can be read by a computer. The storage device 58 stores computer commands and data for controlling the server 4.

The above-mentioned communication may be performed via a mobile communication network such as 3G, 4G, or 5G. Alternatively, the communication may be performed via another wireless communication network such as satellite communication. Alternatively, the communication may be performed via a computer communication network such as LAN, VPN, or the Internet. Alternatively, communication may be performed via a combination of these communication networks.

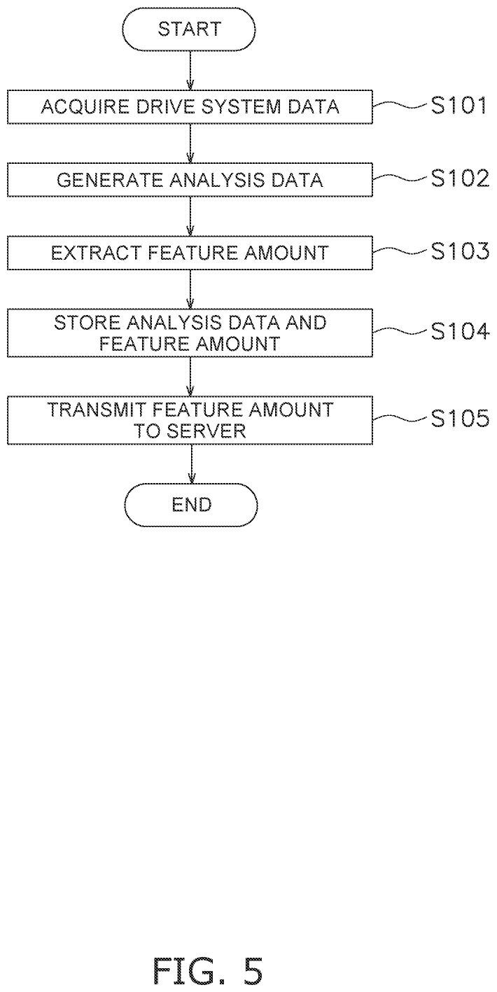

Next, the processing for the predictive maintenance service will be described. FIG. 5 is a flowchart showing the processing executed by the local computers 3A to 3C. Hereinafter, the case where the local computer 3A executes the process illustrated in FIG. 5 will be described, but the other local computers 3B and 3C also execute the same process as the local computer 3A.

As illustrated in FIG. 5, in step S101, the local computer 3A acquires the drive system data from the controller 5A of the industrial machine 2A. The drive system data includes acceleration of a part included in the drive systems 12a to 12d and 32a to 32d. For example, the drive system data includes the angular acceleration of the servomotors 23a to 23d and 36a to 36d. The angular acceleration may be calculated from the rotational speeds of the servomotors 23a to 23d and 36a to 36d. Alternatively, the angular acceleration may be detected by a sensor such as a vibration sensor. Hereinafter, a case where the local computer 3A acquires the drive system data of the drive system 12a will be described.

The local computer 3A acquires the drive system data of the drive system 12a when a predetermined start condition is satisfied. The predetermined start condition includes that a predetermined time has passed since the previous acquisition. The predetermined time is, for example, several hours, but is not limited to this. The predetermined start condition is that the rotation speed of the servomotor 23a exceeds a predetermined threshold value. The predetermined threshold value is preferably a value indicating that, for example, the industrial machine 2A is in operation and not in press working.

The local computer 3A acquires a plurality of values of the angular acceleration of the servomotor 23a at a predetermined sampling cycle. The number of samples is, for example, several hundred to several thousand, but is not limited to this. One unit of drive system data includes a plurality of angular acceleration values sampled within a predetermined time. The predetermined time may be, for example, a time corresponding to several rotations of the servomotor 23a.

In step S102, the local computer 3A generates analysis data. The local computer 3A generates analysis data from the drive system data by, for example, a fast Fourier transform. However, the local computer 3A may use a frequency analysis algorithm different from the fast Fourier transform. The drive system data and the analysis data are examples of state data indicating the state of the drive system of the industrial machine 2A.

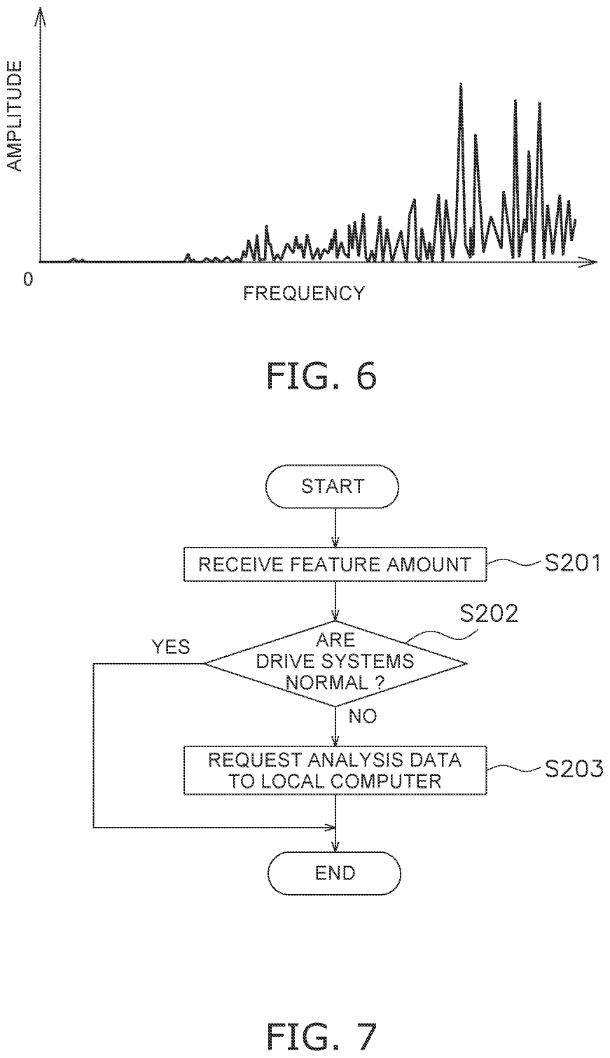

In step S103, the local computer 3A extracts the feature amount from the analysis data. FIG. 6 is a diagram showing an example of analysis data. In FIG. 6, the horizontal axis is frequency and the vertical axis is amplitude. The feature amount is, for example, the value of the peak having an amplitude equal to or higher than the threshold value and the frequency thereof.

In step S104, the local computer 3A stores the analysis data and the feature amount in the storage device 52. The local computer 3A stores the analysis data and the feature amount together with the data indicating the acquisition time of the drive system data corresponding to them. In step S105, the local computer 3A transmits the feature amount to the server 4. Here, the local computer 3A transmits the feature amount to the server 4 instead of the analysis data.

The local computer 3A generates one unit of the state data file for the drive system 12a, and stores the state data file in the storage device 52. One unit of the state data file includes one unit of drive system data, analysis data converted from the drive system data, and a feature amount.

Further, the state data file includes data indicating the time when the state data was acquired. The state data file includes data indicating an identifier of the state data file. The state data file includes data indicating the corresponding drive system identifier. The identifier may be a name or a code. The local computer 3A transmits both the feature amount and the identifier of the state data file corresponding to the feature amount to the server 4.

The local computer 3A executes the same processing as the above processing for the other drive systems 12b to 12d and 32a to 32d. The local computer 3A generates the state data file for each of the other drive systems 12b to 12d and 32a to 32d. The local computer 3A transmits the feature amount and the identifier of the state data file corresponding to the feature amount to the server 4 for each of the other drive systems 12b to 12d and 32a to 32d. Further, the local computer 3A repeats the above-described processing at predetermined time intervals. As a result, a plurality of state data files at predetermined time intervals are stored in the storage device 52. As a result, a plurality of state data files acquired in time series are stored in the storage device 52.

The local computer 3B executes the same processing as the local computer 3A on the industrial machine 2B. Further, the local computer 3C executes the same processing as the local computer 3A on the industrial machine 2C.

FIG. 7 is a flowchart showing the processing executed by the server 4. In the following description, processing when the server 4 receives the feature amount from the local computer 3A will be described. As illustrated in FIG. 7, in step S201, the server 4 receives the feature amount. The server 4 receives the feature amount from the local computer 3A.

In step S202, the server 4 determines whether the drive systems 12a to 12d and 32a to 32d are normal. The server 4 determines whether each of the drive systems 12a to 12d and 32a to 32d is normal from the feature amount corresponding to the drive systems 12a to 12d and 32a to 32d. The determination as to whether the drive systems 12a to 12d and 32a to 32d are normal may be performed by a known determination method in quality engineering. For example, the server 4 uses the MT method (Mahalanobis Taguchi method) to determine whether the drive systems 12a to 12d and 32a to 32d are normal. However, the server 4 may use another method to determine whether the drive systems 12a to 12d and 32a to 32d are normal.

When the server 4 determines in step S202 that at least one of the drive systems 12a to 12d and 32a to 32d is not normal, the process proceeds to step S203. The fact that the drive systems 12a to 12d and 32a to 32d are not normal means that the drive systems 12a to 12d and 32a to 32d have not yet failed, but have deteriorated to some extent.

In step S203, the server 4 requests the analysis data from the local computer 3A. The server 4 transmits the transmission request signal of the analysis data to the local computer 3A. The request signal includes the identifier of the state data file corresponding to the drive system determined to be abnormal. The server 4 transmits the request signal to the local computer 3A and requests the analysis data of the state data file.

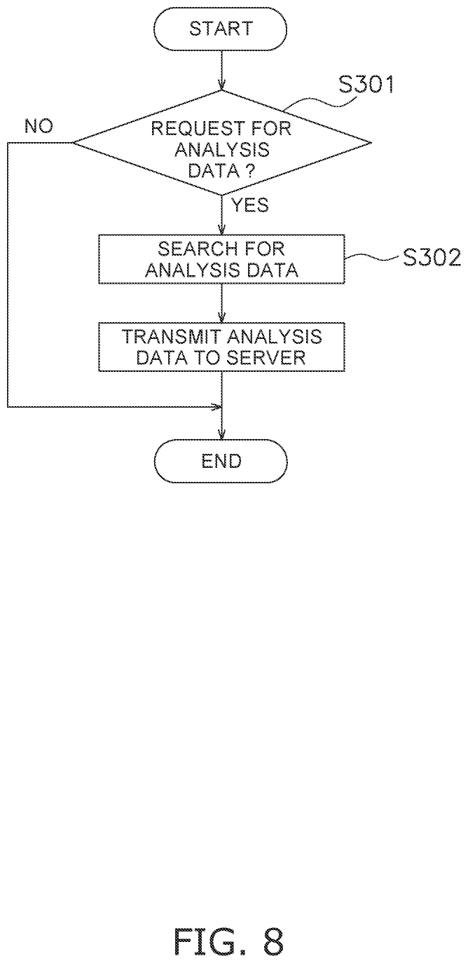

FIG. 8 is a flowchart showing a process executed by the local computer 3A. As illustrated in FIG. 8, in step S301, the local computer 3A determines whether there is a request for analysis data from the server 4. When the local computer 3A receives the above-mentioned request signal from the server 4, it determines that there is a request for analysis data.

In step S302, the local computer 3A searches for analysis data. The local computer 3A searches the analysis data in the requested state data file from the plurality of state data files stored in the storage device 52. In step S303, the local computer 3A transmits the requested analysis data to the server 4.

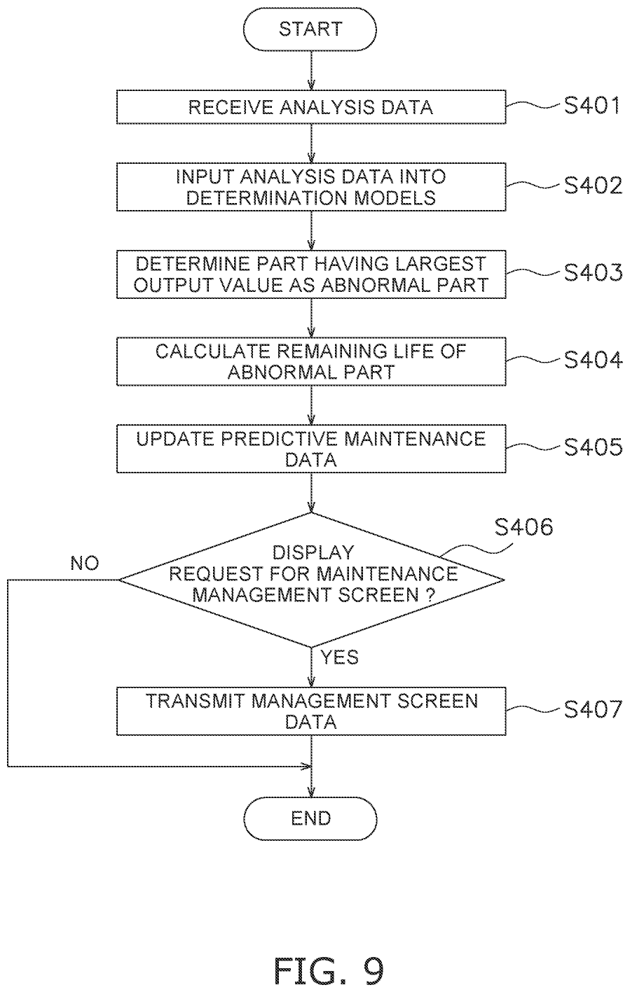

FIG. 9 is a flowchart showing the processing executed by the server 4. As illustrated in FIG. 9, in step S401, the server 4 receives the analysis data from the local computer 3A. The server 4 stores the analysis data in the storage device 58. In step S402, the server 4 inputs the analysis data into the determination models 60 and 70.

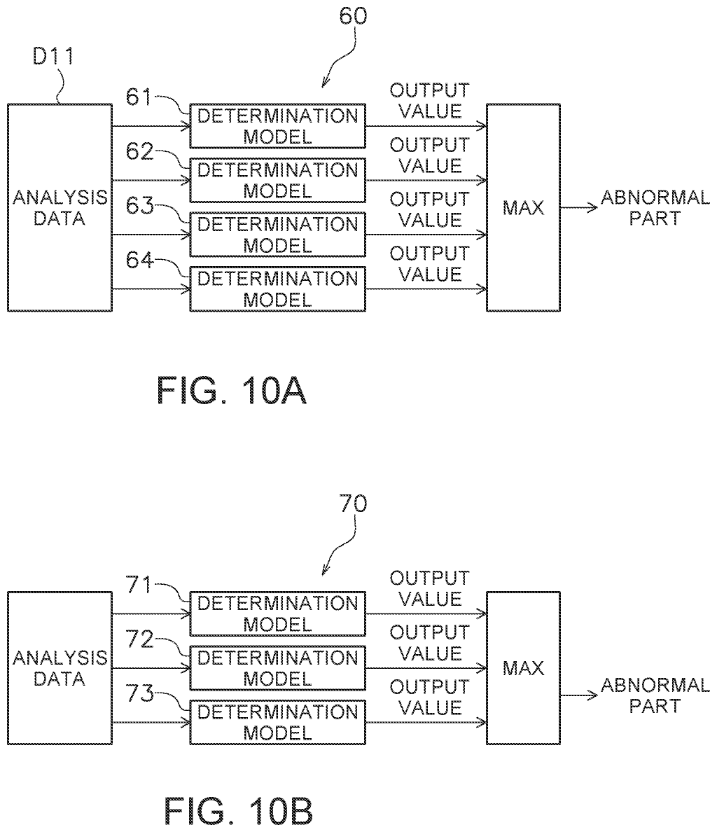

As illustrated in FIGS. 10A and 10B, the server 4 has determination models 60 and 70. The determination models 60 and 70 are models that have been trained by machine learning so as to output the possibility of abnormality of a part included in the drive system by inputting the analysis data. The determination models 60 and 70 include an artificial intelligence algorithm and learning-tuned parameters. The determination models 60 and 70 are stored in the storage device 58 as data. The determination models 60 and 70 include, for example, a neural network. The determination models 60 and 70 include a deep neural network such as a convolutional neural network (CNN).

The server 4 has a determination model 60 for the slide drive systems 12a to 12d and a determination model 70 for the die cushion drive systems 32a to 32d. The determination model 60 includes a plurality of determination models 61 to 64. Each of the plurality of determination models 61 to 64 corresponds to a plurality of parts included in the slide drive systems 12a to 12d. The determination model 60 outputs a value indicating the possibility of abnormality of the corresponding part from the input waveform of the analysis data. The determination models 61 to 64 have been trained by the training data.

The determination model 70 includes a plurality of determination models 71 to 73. Each of the plurality of determination models 71 to 73 corresponds to a plurality of parts included in the die cushion drive systems 32a to 32d. The determination model 70 outputs a value indicating the possibility of abnormality of the corresponding part from the input waveform of the analysis data. The determination models 71 to 73 have been trained by the training data.

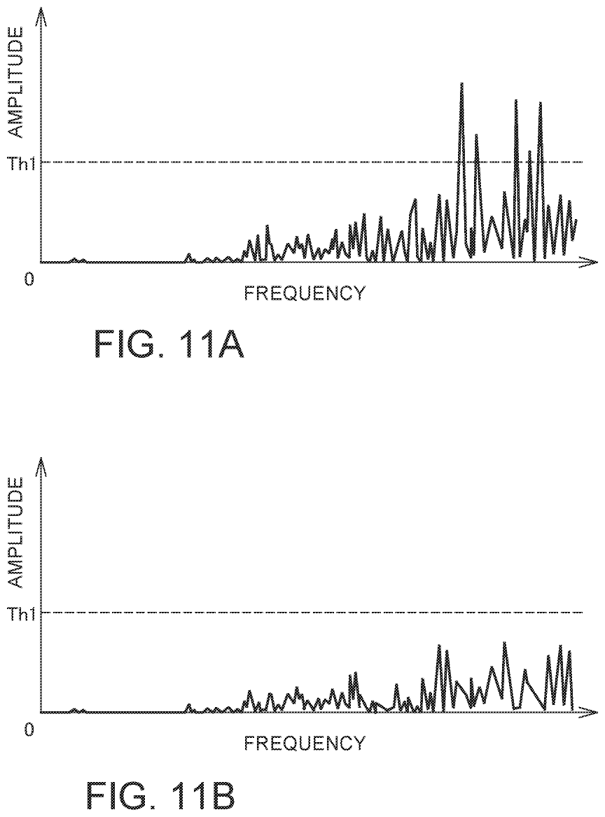

The training data includes analysis data at the time of abnormality and analysis data at the time of normal. FIG. 11A is an example of analysis data at the time of abnormality. FIG. 11B is an example of the analysis data at the time of normal. The analysis data at the time of abnormality is the analysis data from immediately before the occurrence of the abnormality at the corresponding part to a time prior to the occurrence of the abnormality by a predetermined period. As illustrated in FIG. 11A, in the analysis data at the time of abnormality, a plurality of peaks of the waveform exceed a predetermined threshold Th1. The analysis data in the normal state is the analysis data when the usage time of the part is short and no abnormality has occurred. In the normal analysis data, all the peaks of the waveform are lower than the predetermined threshold Th1.

As illustrated in FIG. 10A, in the present embodiment, the server 4 has a determination model 61 for the motor bearing, a determination model 62 for the timing belt, and a determination model 63 for the connecting rod, and a determination model 64 for the speed reducer with respect to the slide drive systems 12a to 12d. The determination model 61 for the motor bearing outputs a value indicating the possibility of abnormality of the motor bearings 28a to 28d from the analysis data. The determination model 62 for the timing belt outputs a value indicating the possibility of abnormality of the timing belts 25a to 25d from the analysis data. The determination model 63 for the connecting rod outputs a value indicating the possibility of abnormality of the connecting rods 26a to 26d from the analysis data. The determination model 64 for the speed reducer outputs a value indicating the possibility of an abnormality in the bearings of the speed reducers 24a to 24d from the analysis data.

As illustrated in FIG. 10B, the server 4 has a determination model 71 for the motor bearing, a determination model 72 for the timing belt, and a determination model 73 for the ball screw with respect to the die cushion drive system 32a to 32d. The determination model 71 for the motor bearing outputs a value indicating the possibility of abnormality of the motor bearings 42a to 42d from the analysis data. The determination model 72 for the timing belt outputs a value indicating the possibility of abnormality of the timing belts 37a to 37d from the analysis data. The determination model 73 for the ball screw outputs a value indicating the possibility of abnormality of the ball screw 38a to 38d from the analysis data.

The server 4 inputs the analysis data acquired in step S401 into each of the above-mentioned determination models 61 to 64 or each of the determination models 71 to 73. For example, when it is determined that the slide drive system 12a is not normal, the server 4 inputs the analysis data of the slide drive system 12a into the determination models 61 to 64. As a result, the server 4 acquires a value indicating the possibility of abnormality in each part of the slide drive system 12a as an output value.

Alternatively, when it is determined that the die cushion drive system 32a is not normal, the server 4 inputs the analysis data of the die cushion drive system 32a into the determination models 71 to 73. As a result, the server 4 acquires a value indicating the possibility of abnormality in each part of the die cushion drive system 32a as an output value.

In step S403, the server 4 determines that the part having the largest output value is the abnormal part. For example, the server 4 determines, as the abnormal part, a part corresponding to the largest output value among the output values from the determination model 61 for the motor bearing, the determination model 62 for the timing belt, the determination model 63 for the connecting rod, and the determination model 64 for the speed reducer with respect to the slide drive system 12a. Alternatively, the server 4 determines, as the abnormal part, a part corresponding to the largest output value among the output values from the determination model 71 for the motor bearing, the determination model 72 for the timing belt, and the determination model 73 for the ball screw with respect to the die cushion drive system 32a.

In step S404, the server 4 calculates the remaining life of the abnormal part. For example, the server 4 may calculate the remaining life of the abnormal part by using a known method of quality engineering such as the MT method (Mahalanobis Taguchi method). However, the server 4 may calculate the remaining life by using another method.

In step S405, the server 4 updates the predictive maintenance data. The predictive maintenance data is stored in the storage device 58. The predictive maintenance data includes data indicating the remaining life of the drive system of the industrial machines 2A to 2C registered in the server 4. The predictive maintenance data includes data indicating the remaining life of the part determined to be the abnormal part among the plurality of parts of the drive system.

In step S406, the server 4 determines whether there is a display request for the maintenance management screen. When the server 4 receives the request signal of the maintenance management screen from the client computer 6, it determines that there is the display request of the maintenance management screen. When there is the display request for the maintenance management screen, the server 4 transmits the management screen data. The management screen data is data for displaying the maintenance management screen on the display 7 of the client computer 6.

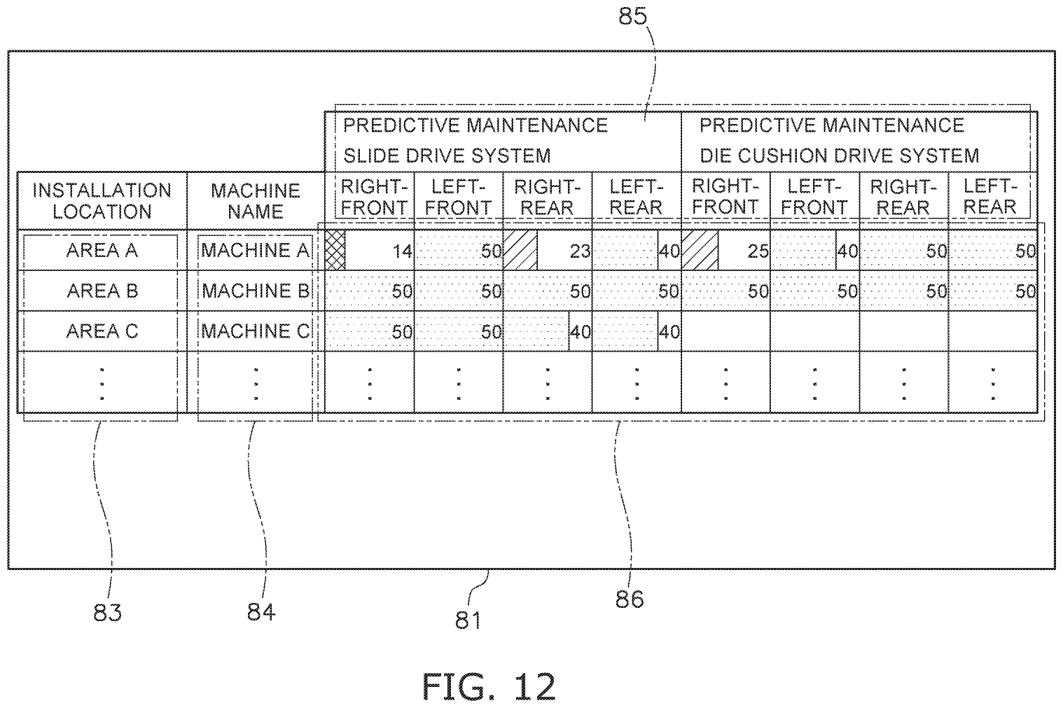

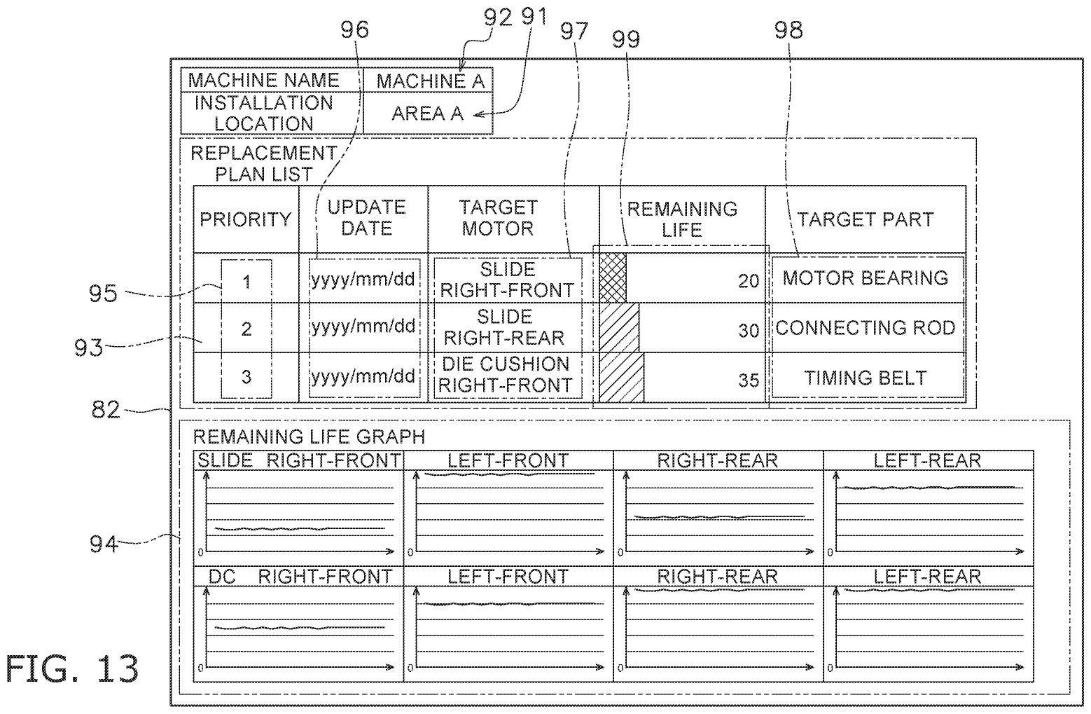

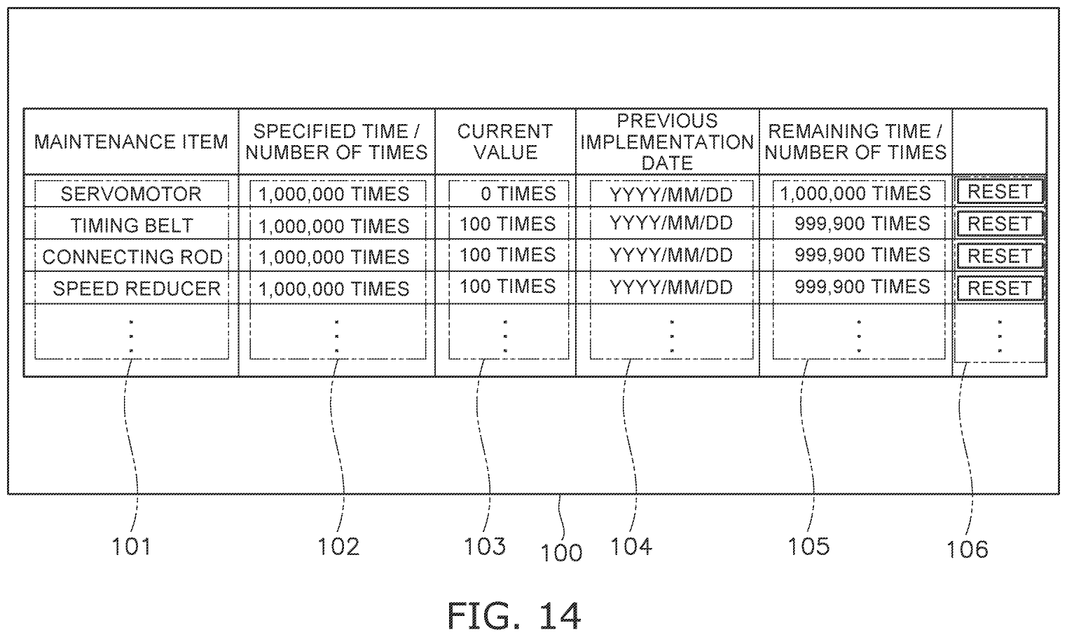

FIGS. 12 to 14 are views showing an example of the maintenance management screen. The maintenance management screen includes a machine list screen 81 illustrated in FIG. 12, a machine individual screen 82 illustrated in FIG. 13, and a maintenance part management screen 100 illustrated in FIG. 14. The user of the client computer 6 can selectively display the machine list screen 81 and the machine individual screen 82 on the display 7. When the machine list screen 81 is selected, the server 4 generates data indicating the machine list screen 81 based on the predictive maintenance data, and transmits the data indicating the machine list screen 81 to the client computer 6. When the machine individual screen 82 is selected, the server 4 generates data indicating the machine screen based on the predictive maintenance data, and transmits the data indicating the machine individual screen 82 to the client computer 6.

FIG. 12 is a diagram showing an example of the machine list screen 81. The machine list screen 81 displays predictive maintenance data related to a plurality of industrial machines 2A to 2C registered in the server 4. As illustrated in FIG. 12, the machine list screen 81 includes an area identifier 83, a machine identifier 84, a drive system identifier 85, and a life indicator 86. On the machine list screen 81, the area identifier 83, the machine identifier 84, the drive system identifier 85, and the life indicator 86 are displayed in a list.

The area identifier 83 is an identifier of the area where the industrial machines 2A to 2C are arranged. The machine identifier 84 is an identifier for each of the industrial machines 2A to 2C. The drive system identifier 85 is an identifier of the slide drive systems 12a to 12d or the die cushion drive systems 32a to 32d. These identifiers may be names or codes.

The life indicator 86 indicates the remaining life of the slide drive systems 12a to 12d or the die cushion drive systems 32a to 32d for each of the industrial machines 2A to 2C. The life indicator 86 includes a numerical value indicating the remaining life. The remaining life is indicated by, for example, the number of days. However, the remaining life may be expressed in other units such as hours.

The life indicator 86 also includes a graphic display indicating the remaining life. In the present embodiment, the graphic display is a bar display. The server 4 changes the length of the bar of the life indicator 86 according to the remaining life. However, the remaining life may be displayed by another display mode.

Similar to step S404, the server 4 may determine the remaining life from the feature amount of the drive system determined to be normal, and display the remaining life with the life indicator 86. The server 4 may display the remaining life of the abnormal part determined in step S404 described above with the life indicator 86 for the drive system including the abnormal part.

On the machine list screen 81, the server 4 displays a plurality of drive system life indicators 86 in different colors according to the remaining life. For example, when the remaining life is equal to or greater than the first threshold value, the server 4 displays the life indicator 86 in a normal color. When the remaining life is smaller than the first threshold value and equal to or larger than the second threshold value, the server 4 displays the life indicator 86 in the first warning color. When the remaining life is smaller than the second threshold value, the server 4 displays the life indicator 86 in the second warning color. The second threshold value is smaller than the first threshold value. The normal color, the first warning color, and the second warning color are different colors from each other. Therefore, the life indicator 86 of the part having a short remaining life is displayed in a different color from the life indicator 86 of the normal part.

FIG. 13 is a diagram showing an example of the machine individual screen 82. When the server 4 receives the request signal of the machine individual screen 82 from the client computer 6, the server 4 transmits data for displaying the machine individual screen 82 on the display 7 to the client computer 6. The machine individual screen 82 displays predictive maintenance data for one industrial machine selected from the plurality of industrial machines 2A to 2C registered in the server 4. However, the machine individual screen 82 may display predictive maintenance data for a plurality of selected industrial machines.

Hereinafter, the machine individual screen 82 when the industrial machine 2A is selected will be described. The machine individual screen 82 includes an area identifier 91, an industrial machine identifier 92, a replacement plan list 93, and a remaining life graph 94. The area identifier 91 is an identifier of the area in which the industrial machine 2A is arranged. The machine identifier 92 is an identifier of the industrial machine 2A.

The replacement plan list 93 displays predictive maintenance data for a part to be maintained among a plurality of parts. The part determined to be the abnormal part by the above-mentioned determination models 60 and 70 is displayed in the replacement plan list 93. Therefore, when the server 4 determines that there is an abnormality in at least one of the plurality of parts, the server 4 can notify the user of the abnormality by displaying the part in the replacement plan list 93.

In the replacement plan list 93, at least a part of a plurality of parts included in each drive system of the industrial machine 2A is displayed in order from the one having the shortest remaining life. The replacement plan list 93 includes a priority 95, an update date 96, a drive system identifier 97, a part identifier 98, and a life indicator 99.

The priority 95 indicates the priority of replacement of a part of the drive system. The shorter the remaining life, the higher the priority 95. Therefore, in the replacement plan list 93, the identifier 98 and the life indicator 99 of the part having the shortest remaining life are displayed at the highest level. The update date 96 indicates the date of the previous replacement of the drive system part. The drive system identifier 97 is an identifier of the slide drive systems 12a to 12d or the die cushion drive systems 32a to 32d.

The part identifier 98 is an identifier of a part included in the drive system. For example, the part identifier 98 is an identifier of the servomotor, the speed reducer, the timing belt, or the connecting rod of the slide drive systems 12a to 12d. Alternatively, it is an identifier of the servomotor, the timing belt, or the ball screw of the die cushion drive systems 32a to 32d. The server 4 displays the identifier 98 of the part determined to be the abnormal part using the determination models 60 and 70 described above in the replacement plan list 93. These identifiers may be names or codes.

The life indicator 99 indicates the remaining life of each part of the slide drive systems 12a to 12d or the die cushion drive systems 32a to 32d. The life indicator 99 includes a numerical value indicating the remaining life of each part and a graphic display. Since the life indicator 99 is the same as the life indicator 86 on the machine list screen 81 described above, the description thereof will be omitted.

The remaining life graph 94 is a graph of the remaining life of each of the drive systems 12a to 12d and 32a to 32d. The remaining life in the graph 94, the horizontal axis is the time when the state data was acquired, and the vertical axis is the remaining life calculated from the feature amount.

FIG. 14 is a diagram showing an example of the maintenance part management screen 100. As illustrated in FIG. 14, the maintenance part management screen 100 includes display of each of the maintenance item 101, the specified time/number of times 102, the current value 103, the previous implementation date 104, and the remaining time/number of times 105. In addition, the maintenance part management screen 100 includes a reset operation display 106. The maintenance item 101 indicates a part to be maintained. For example, maintenance item 101 indicates the servomotor, the speed reducer, the timing belt, or the connecting rod of the slide drive systems 12a to 12d described above. The maintenance item 101 may indicate maintenance work for each part.

The specified time/number of times 102 indicates the operating time or the number of operating times as a guideline for replacement of each part. The current value 103 indicates the operating time or the number of operating times of each part up to the present. The previous implementation date 104 indicates the implementation date of the previous maintenance work for each part. The maintenance work is, for example, replacement of parts. For example, in the maintenance work, the part having a short machine life illustrated on the machine individual screen 82 is replaced. The remaining time/number of times 105 indicates the remaining operating time or the number of operating times up to the specified time/number of times 102. These parameters are transmitted from the controllers 5A to 5C of the industrial machines 2A to 2C to the server 4 via the local computers 3A to 3C, and are stored in the storage device 58 of the server 4 as predictive maintenance data.

The reset operation display 106 is a display for the user to perform an operation of resetting the current value 103 and the remaining time/number of times 105 of each part to return to the initial values. The user operates the reset operation display 106 using a user interface such as a pointing device. When the maintenance work is performed on a certain part, the user operates the reset operation display 106 of the part on the maintenance part management screen 100. When the reset operation display 106 is operated, the client computer 6 transmits a signal indicating the completion of the maintenance work to the server 4. The signal indicating the completion of the maintenance work includes an identifier indicating the part that has undergone the maintenance work and a reset request. When the server 4 receives the signal indicating the completion of the maintenance work, the server 4 resets the current value 103 and the remaining time/number of times 105 of the relevant part to return to the initial values, and updates the predictive maintenance data.

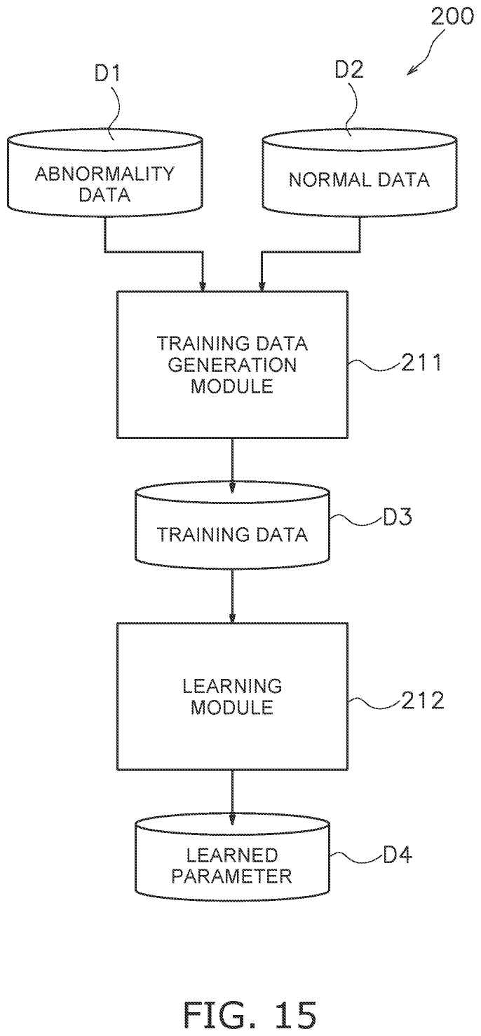

Next, a system for training the determination models 60 and 70 will be described. FIG. 15 is a diagram showing a learning system 200 that learns the determination models 60 and 70. The learning system 200 includes a training data generation module 211 and a learning module 212. The training data generation module 211 generates training data D3 from abnormality data D1 and normal data D2. The abnormality data D1 includes analysis data at the time of abnormality and data indicating a part where the abnormality has occurred. The normal data D2 includes the analysis data at the normal time. The normal data D2 may include data indicating a normal part together with the analysis data at the time of normal.

The training data generation module 211 is implemented in the server 4. The server 4 uses a signal from the client computer 6 indicating the completion of the maintenance work as a trigger to extract analysis data corresponding to the trigger. That is, the signal indicating the completion of the maintenance work indicates the occurrence of a trigger related to the occurrence of the abnormality in the industrial machines 2A to 2C.

Specifically, the server 4 acquires the trigger generation time. The trigger generation time may be the time when the reset operation display 106 is operated. Alternatively, the trigger generation time may be the time when the server 4 receives the signal indicating the completion of the maintenance work. The server 4 extracts the analysis data acquired within a predetermined time before the trigger generation time from the analysis data as the data corresponding to the trigger. The server 4 may extract the analysis data by using the process for requesting the analysis data illustrated in FIG. 8. When the extracted analysis data exceeds the threshold value Th1 illustrated in FIGS. 11A and 11B, the server 4 adds the analysis data to the abnormality data D1 together with the data indicating the part where the abnormality has occurred.

The analysis data at the normal time may be prepared by a test such as acquiring the analysis data of a new industrial machine. Alternatively, the server 4 may extract the analysis data acquired within a predetermined time after the trigger generation time as the analysis data in the normal state. The server 4 may add the analysis data to the normal data D2 when the extracted analysis data does not exceed the threshold Th1 illustrated in FIGS. 11A and 11B.

The learning module 212 optimizes the parameters of the determination models 60 and 70 by learning the determination models 60 and 70 using the training data D3. The learning module 212 acquires the optimized parameter as the learned parameter D4. The learning module 212 may be implemented on the server 4 in the same manner as the training data generation module 211. Alternatively, the learning module 212 may be implemented on a computer other than the server 4.

The learning system 200 may update the learned parameter D4 by periodically executing the learning of the determination models 60 and 70 described above. The server 4 may update the determination models 60 and 70 according to the updated learned parameter D4.

In the present embodiment described above, the server 4 determines the occurrence of a trigger related to the occurrence of an abnormality in the industrial machines 2A to 2C. When the trigger occurs, the server 4 extracts the analysis data corresponding to the trigger. The server 4 stores the analysis data corresponding to the trigger as the training data D3. Thereby, the training data D3 with high accuracy can be easily collected.

Although one embodiment of the present invention has been described above, the present invention is not limited to the above embodiment, and various modifications can be made without departing from the gist of the invention. For example, the industrial machine is not limited to a press machine, but may be a welding machine or another machine such as a cutting machine. A part of the above-mentioned processing may be omitted or changed. The order of the above-mentioned processes may be changed.

The configuration of the local computers 3A to 3C may be changed. For example, the local computer 3A may include a plurality of computers. The above-mentioned processing by the local computer 3A may be distributed to a plurality of computers and executed. The local computer 3A may include a plurality of processors. The other local computers 3B and 3C may be changed in the same manner as the local computer 3A.

The configuration of the server 4 may be changed. For example, the server 4 may include a plurality of computers. The processing by the server 4 described above may be distributed to a plurality of computers and executed. The server 4 may include a plurality of processors. At least a part of the above-mentioned processing may be executed not only by the CPU but also by another processor such as a GPU (Graphics Processing Unit). The above-mentioned processing may be distributed to a plurality of processors and executed.

The determination model is not limited to the neural network, and may be another machine learning model such as a support vector machine. The determination models 61 to 64 may be integrated. The determination models 71 to 73 may be integrated.

The determination model is not limited to the model learned by machine learning using the training data D3, and may be a model generated by using the learned model. For example, the determination model may be another trained model (derivative model) in which the parameters are changed and the accuracy is further improved by further training the trained model using new data. Alternatively, the determination model may be another trained model (distillation model) trained based on the result obtained by repeating the input/output of data to the trained model.

The part to be determined by the determination model is not limited to that of the above embodiment, and may be changed. The state data is not limited to the angular acceleration of the motor and may be changed. For example, the state data may be the acceleration or speed of a part other than the motor such as a timing belt or a connecting rod.

The maintenance management screen is not limited to that of the above embodiment, and may be changed. For example, the items included in the machine list screen 81, the machine individual screen 82, and/or the maintenance part management screen 100 may be changed. The display mode of the machine list screen 81, the machine individual screen 82, and/or the maintenance part management screen 100 may be changed. A part of the machine list screen 81, the machine individual screen 82, and the maintenance part management screen 100 may be omitted.

The display mode of the life indicator 86 is not limited to that of the above embodiment, and may be changed. For example, the number of color coding of the life indicator 86 may be two colors, a normal color and a first warning color. Alternatively, the number of color coding of the life indicators 86 may be more than three.

The determination result of the part to be maintained by the determination model is not limited to the maintenance management screen described above, and may be notified to the user by another method. For example, the determination result may be notified to the user by a notification means such as an e-mail.

The trigger is not limited to the signal indicating the completion of the maintenance work, and may be another signal. The signal indicating the completion of the maintenance work is not limited to the signal from the client computer 6. For example, the signal indicating the completion of the maintenance work may be a signal from the local computers 3A to 3C.

The server 4 may determine the presence or absence of an abnormality by comparing the data before the trigger occurrence and the data after the trigger occurrence among the state data. For example, when the peak of the waveform in the analysis data before the occurrence of the trigger is larger than that in the analysis data after the occurrence of the trigger, the server 4 may determine that there is an abnormality. When the server 4 determines that there is an abnormality, the server 4 may store the analysis data corresponding to the trigger as the training data D3.

In step S105, the local computer 3A may transmit the feature amount and the analysis data to the server 4. In that case, step S203 may be omitted.

According to the present disclosure, it is possible to easily collect accurate training data for training a determination model of artificial intelligence for determining an abnormality of an industrial machine.

1. A system for collecting training data for training a determination model of artificial intelligence that determines an abnormality of an industrial machine, the system comprising:
a storage device that stores state data indicative of a state of the industrial machine acquired in time series; and
a processor configured to
determine an occurrence of a trigger related to an occurrence of the abnormality in the industrial machine, and extract data corresponding to the trigger from the state data when the trigger occurs, and
store the data corresponding to the trigger as the training data.

2. The system according to claim 1, wherein
the storage device stores data indicative of an acquisition time of the state data together with the state data,
the processor is further configured to
acquire a generation time of the trigger, and
extract data acquired within a predetermined time corresponding to the generation time of the trigger as the data corresponding to the trigger.

3. The system according to claim 2, wherein
the processor is configured to extract data acquired within the predetermined time before the generation time of the trigger as the data corresponding to the trigger.

4. The system according to claim 1, wherein
the industrial machine includes a plurality of parts, and
the trigger includes information usable to identify a part of the plurality of parts where the abnormality has occurred.

5. The system according to claim 1, wherein
the trigger is a signal indicative of completion of maintenance work of the industrial machine.

6. The system according to claim 5, wherein
the processor is further configured to
determine presence or absence of the abnormality by comparing data before the occurrence of the trigger with data after the occurrence of the trigger, and
store the data corresponding to the trigger as the training data upon determining the presence of the abnormality.

7. A method performed by a processor for collecting training data for training a determination model of artificial intelligence that determines an abnormality in an industrial machinery, the method comprising:
acquiring state data indicative of a state of the industrial machine in time series;
storing the state data;
determining an occurrence of a trigger related to an occurrence of the abnormality in the industrial machine;
extracting data corresponding to the trigger from the state data when the trigger occurs; and
storing the data corresponding to the trigger as the training data.

8. The method according to claim 7, further comprising:
acquiring data indicative of an acquisition time of the state data together with the state data; and
acquiring a generation time of the trigger,
the data acquired within a predetermined time corresponding to the generation time of the trigger from the state data being extracted as the data corresponding to the trigger.

9. The method according to claim 8, wherein
the data acquired within the predetermined time before the generation time of the trigger is extracted as the data corresponding to the trigger.

10. The method according to claim 7, wherein
the industrial machine includes a plurality of parts, and
the trigger includes information usable to identify a part of the plurality of parts where an abnormality has occurred.

11. The method according to claim 7, wherein
the trigger is a signal indicative of completion of maintenance work of the industrial machine.

12. The method according to claim 11, further comprising:
determining presence or absence of the abnormality by comparing data before the occurrence of the trigger and data after the occurrence of the trigger,
the data corresponding to the trigger being stored as the training data upon determining the presence of the abnormality.
